(19) United States
(12) Patent Application Publication
(10) Pub. No.: US 2026/0258910 A1
(43) Pub. Date: Sep. 3, 2026

(54) DISPENSING OF GASEOUS HYDROGEN COMPRISING SPLIT PRESSURE REDUCTION

(71) Applicant: ANGI Energy Systems LLC, Janesville, WI (US)

(72) Inventors: Ryan SALBERG, Rockford, IL (US); Jake BOKORNEY, McCleansville, NC (US); Nicholas FREDRICK, Milton, WI (US)

(21) Appl. No.: 19/281,182

(22) Filed: Jul. 25, 2025

Related U.S. Application Data
(60) Provisional application No. 63/765,862, filed on Mar. 3, 2025.

(51) Int. Cl. F17C 5/00

(52) U.S. Cl. CPC F17C 5/007; F17C 2250/043; F17C 2250/0439; F17C 2250/0626; F17C 2270/0139

(57) ABSTRACT

A method is described for controlling delivery of compressed gaseous hydrogen from a high pressure source to a receiving storage tank (for example, deployed within a vehicle) via an intervening dispenser, where the dispenser is operatively connected to the receiving storage tank and a chiller is deployed between the high pressure source and the dispenser. A pressure ramp rate for providing the gaseous hydrogen to the receiving storage tank is determined. Based on the pressure ramp rate, respective first and second reductions in pressure of the gaseous hydrogen from the high pressure source to the chiller and from the chiller to the receiving storage tank are controlled such that the first reduction in pressure is greater than the second reduction in pressure. Delivery of the gaseous hydrogen to the receiving storage tank is discontinued when a target state of the receiving storage tank is achieved.

### FIELD

The present disclosure generally concerns dispensing of gaseous hydrogen and, in particular, to techniques for dispensing gaseous hydrogen comprising split pressure reduction.

### BACKGROUND

While demand for alternative fuel vehicles is expected to increase in coming years, the rate of growth for such vehicles is necessarily dependent upon the availability of fueling options for consumers. As the number of such options increases and therefore become more widely available, uptake of alternative fuel vehicles becomes easier and more attractive for consumers.

One significant option in the realm of alternative fuel vehicles are fuel cell electric vehicles (FCEVs), which typically rely on the use of pressurized hydrogen fuel and fuel cells for the pollution-free generation of electricity that, in turn, is used to power electric drive motors on FCEVs. The continued growth of FCEVs will be driven, in part, by the availability of hydrogen refilling stations in which hydrogen fuel is supplied to consumers in much the same manner that petroleum products (gasoline and diesel) are currently supplied to consumers owning internal combustion engine vehicles.

FIG. 1, illustrates an example of a prior art hydrogen refilling station 100 (HRS). Such an HRS 100 will typically comprise a high pressure source 101 of gaseous hydrogen. For example, in the illustrated embodiment, the high pressure source 101 comprises one or more hydrogen supply sources 102 of gaseous hydrogen feeding one or more compressors 104 that, in turn, pressurize the gaseous hydrogen to relatively high pressures for storage in one or more high pressure storage vessels 106. For example, for the refilling of vehicle storage tanks capable of storing hydrogen at 350 bar, the gaseous hydrogen stored in the high pressure storage 106 will typically be pressurized to about 500 bar, whereas the refilling of vehicle storage tanks capable of storing hydrogen at 700 bar, the gaseous hydrogen stored in the high pressure storage 106 will typically be pressurized to about 900 bar.

As known in the art, the hydrogen supply source(s) 102 may be implemented in any of a variety of manners. For example, according to one method, a compressed hydrogen gas delivery trailer (e.g., a tube trailer) delivers compressed hydrogen to the HRS site, which hydrogen may then be stored in a low pressure storage tank. As needed, hydrogen gas is drawn from the low pressure storage tank and pressurized by the compressor 104 and thereafter provided to the high pressure storage. In another example, a liquid hydrogen delivery trailer delivers liquid hydrogen to a liquid hydrogen storage tank. As needed, liquid hydrogen is drawn from the storage tank and provided to a vaporizer that converts the liquid hydrogen into a gaseous form that is then pressurized by the compressor 104. In yet another example, the compressor 104 may be capable of providing high pressure gaseous hydrogen directly to the dispenser 108 without the need for high pressure storage 106. Still further implementations will be known to those skilled in the art.

FIG. 1 further depicts a dispenser 108 that may be used to dispense gaseous hydrogen to a vehicle 110, more particularly, to a vehicle's hydrogen storage tank 122 (sometimes referred to in the art as a compressed hydrogen storage system (CHSS) and also referred to herein as a receiving storage tank). When hydrogen delivery is required by the dispenser 108, sufficiently pressurized hydrogen gas is drawn from the high pressure storage 106 and routed to a pressure control device 114, which is configured by a controller 112 to regulate the delivery of the pressurized hydrogen (through a nozzle 120 of the dispenser 108 and a mating fixture 124 provided in the vehicle) to the receiving storage tank 122. As shown, the receiving storage tank 122 is typically monitored by on-board pressure and temperature sensors 126, 128 that provide pressure and temperature readings of the receiving storage tank 122 to the controller 112. As known in the art, the controller 112, which may comprise a suitable processing device, continuously monitors the pressure and temperature data received from the vehicle sensors 126, 128 as well as (though not shown in FIG. 1) other data sources such as, but not necessarily limited to, the hydrogen temperature, pressure and flowrate within the dispenser 108 and at the output of the high pressure storage 106, as well as the size of the receiving storage tank. Based on at least this information, the controller 108 uses an algorithm, such as the so-called “MC formula” as described in the well-known SAE J2601 standard, to determine a pressure ramp rate, which refers to the controlled rate (often expressed in terms of bar per minute or MPa per minute) at which the pressure of hydrogen delivered to the receiving storage tank 122 varies (generally increasing) during a refilling process.

A known limitation to delivering gaseous hydrogen in HRSs is the property of hydrogen to increase in temperature when passing from a higher pressurized state through a restriction (such as a pressure control device or nozzle as described herein) into a lower pressurized state, i.e., the so-called reverse Joule-Thompson effect. Typically, when a gas (such as natural gas and CO₂) is depressurized after passing through a restriction such as a valve, the gas will cool rapidly. On the other hand, hydrogen, in most environments, heats up as it depressurizes through a valve. In the case of hydrogen fuel systems, such heating occurring at the point of delivery could contribute to heating of a vehicle's receiving storage tank 122, which in turn could lead to premature (and potentially catastrophic) tank failure.

To minimize this risk, a chiller or refrigeration unit 118 may be provided in the dispenser 108 at the output of the pressure control device 114. As the gaseous hydrogen passes from the high pressure storage 106 and through the pressure control device 114, any heating of the hydrogen is counteracted by the cooling effect of the chiller 118 (e.g., down to as low as −40° C.) thereby reducing heating of the receiving storage tank 122. When refilling is initiated and the receiving storage tank 122 is at its lowest pressure, the pressure ramp rate must be carefully controlled because the pressure difference between the high pressure storage 103 and the low pressure environment of the receiving storage tank 122 is at its greatest and could lead to significant heating. Because the chiller 118 is limited in its ability to effectuate rapid cooling of the hydrogen, it becomes necessary to significantly lower the pressure ramp rate (i.e., to slow down the rate of hydrogen delivery) to maintain safe temperatures at the receiving storage tank 122. This, in turn, increases the time required to complete the refill process, which is not desirable.

An alternative configuration is to place the chiller 118 externally relative to the dispenser 108, between the output of the high pressure storage 106 and the pressure control device 114, thus simplifying the design and construction of the dispenser 108. Such pre-chilling of the hydrogen to ensure suitable ramp rates during all phases of the refilling operation is highly inefficient due to the significant warming that will be incurred subsequent to the pressure control device 114.

Thus, techniques that overcome the difficulties in cooling efficiency and delivery times for HRSs described above would represent a welcome addition to the art.

### SUMMARY

The instant disclosure describes techniques for the dispensing of gaseous hydrogen that address the above-noted shortcomings. In an embodiment, a method is provided for controlling delivery of compressed gaseous hydrogen from a high pressure source to a receiving storage tank via an intervening dispenser, where the dispenser is operatively connected to the receiving storage tank and a chiller is deployed between the high pressure source and the dispenser. The method comprises determining a pressure ramp rate for providing the gaseous hydrogen to the receiving storage tank. Based on the pressure ramp rate, a first reduction in pressure of the gaseous hydrogen from the high pressure source to the chiller is controlled, and a second reduction in pressure from the chiller to the receiving storage tank is likewise controlled such that the first reduction in pressure of the gaseous hydrogen is greater than the second reduction in pressure of the gaseous hydrogen. In this embodiment, the method may be performed continuously by the dispenser and, further, the controlling of the first and second reductions in pressure may occur substantially simultaneously. Further still, in an embodiment, a vehicle is operatively connected to the dispenser, wherein the receiving storage tank is deployed in the vehicle and gaseous hydrogen is delivered to the receiving storage tank according to the pressure ramp rate. Delivery of the gaseous hydrogen to the receiving storage tank is discontinued when a target state of the receiving storage tank is achieved.

In an embodiment, the determination of the pressure ramp rate is based upon at least one of an initial pressure of the receiving storage tank, ambient temperature at the dispenser, pressure of the gaseous hydrogen delivered to the receiving storage tank, or temperature of the gaseous hydrogen delivered to the receiving storage tank.

In an embodiment, a first pressure control device is configured to receive the gaseous hydrogen from the high pressure source and provide the gaseous hydrogen to the chiller, and a second pressure control device is configured to receive the gaseous hydrogen from the chiller and provide the gaseous hydrogen to the receiving storage tank. In this embodiment, the first reduction in pressure and the second reduction in pressure includes respectively communicating first and second operating setpoints to the first and second pressure control devices, wherein the first reduction in pressure of the gaseous hydrogen is effectuated by the first pressure control device operating according to the first operating setpoint, and the second reduction in pressure of the gaseous hydrogen is effectuated by the second pressure control device operating according to the second operating setpoint. In an embodiment, the first and second operating setpoints may be determined based upon the respective temperature, pressure and flow rate of the gaseous hydrogen at the first and pressure control devices.

In another embodiment, a dispenser for use in a gaseous hydrogen dispensing system comprises a dispenser pressure control device configured to receive gaseous hydrogen from a chiller, a nozzle, in fluid communication with the dispenser pressure control device and configured to be in fluid communication with a receiving storage tank in a vehicle and a controller operatively connected to the dispenser pressure control device. The controller comprises a processing device configured to determine a pressure ramp rate for providing the gaseous hydrogen to the receiving storage tank via the nozzle. Based on the pressure ramp rate, the controller determines a dispenser operating setpoint for the dispenser pressure control device, wherein a dispenser reduction in pressure of the gaseous hydrogen is effectuated by the dispenser pressure control device when operating according to the dispenser operating setpoint. Likewise, based on the pressure ramp rate, the controller determines an upstream operating setpoint for an upstream pressure control device that is upstream of, and configured to provide the gaseous hydrogen to, the chiller, wherein an upstream reduction in pressure of the gaseous hydrogen is effectuated by the upstream pressure control device when operating according to the upstream operating setpoint. In this embodiment, the upstream reduction in pressure of is greater than the dispenser reduction in pressure. The controller further operate to communicate the dispenser operating setpoint to the dispenser pressure control device and the upstream operating setpoint to the upstream pressure control device.

In an embodiment, the dispenser's processing device is further configured to determine the pressure ramp rate based upon at least one of an initial pressure of the receiving storage tank, ambient temperature at the dispenser, pressure of the gaseous hydrogen delivered to the receiving storage tank, or temperature of the gaseous hydrogen delivered to the receiving storage tank.

In an embodiment, the dispenser's processing device is further configured to determine the dispenser operating setpoint based upon the temperature, pressure and flow rate of the gaseous hydrogen at the dispenser pressure control device, and to determine the upstream operating setpoint based upon the temperature, pressure and flow rate of the gaseous hydrogen at the upstream pressure control device.

In an embodiment, the dispenser's processing device is further configured to deliver the gaseous hydrogen to the receiving storage tank via the dispenser pressure control device according to the pressure ramp rate. The dispenser's processing device is also further configured to discontinue delivery of the gaseous hydrogen to the receiving storage tank when a target state of the receiving storage tank is achieved.

In yet another embodiment, a gaseous hydrogen dispensing system comprises a high pressure source of gaseous hydrogen, a first pressure control device configured to receive gaseous hydrogen from the high pressure source, a chiller configured to receive the gaseous hydrogen from the first pressure control device and a dispenser in fluid communication with the chiller and a receiving storage tank (which may be deployed in a vehicle), the dispenser comprising a second pressure control device configured to receive the gaseous hydrogen from the chiller and deliver the gaseous hydrogen to the receiving storage tank. Further to this embodiment, the dispenser comprises a controller operatively connected to the first pressure control device and the second pressure control device. The controller is configured to determine a pressure ramp rate for providing the gaseous hydrogen to the receiving storage tank and control the first pressure control device according to a first operating setpoint and the second pressure control device according to a second operating setpoint, wherein the first operating setpoint and the second operating setpoint are based on the pressure ramp rate and wherein a first reduction in pressure of the gaseous hydrogen by the first pressure control device according to the first operating setpoint is greater than a second reduction in pressure of the gaseous hydrogen by the second pressure control device according to the second operating setpoint.

In various embodiments of the system, the high pressure source may be an output of a storage tank or the output of a compressor.

In an embodiment of the system, the chiller may be configured to cool the gaseous hydrogen to about −40° C.

In an embodiment of the system, the determination of the pressure ramp rate is based upon at least one of an initial pressure of the receiving storage tank, ambient temperature at the dispenser, pressure of the gaseous hydrogen delivered to the receiving storage tank, or temperature of the gaseous hydrogen delivered to the receiving storage tank.

In an embodiment of the system, the first and second operating setpoints may be determined based upon the respective temperature, pressure and flow rate of the gaseous hydrogen at the first and pressure control devices.

### BRIEF DESCRIPTION OF THE DRAWINGS

The foregoing and other features and advantages will be discussed in detail in the following non-limiting description of specific embodiments in connection with the accompanying drawings, in which:

FIG. 1 is a schematic block diagram illustrating a hydrogen refilling station in accordance with prior art techniques;

FIG. 2 is a schematic block diagram illustrating a hydrogen refilling station in accordance with the instant disclosure;

FIG. 3 is a block diagram of a processing device that may be used to implement a controller of a dispenser in accordance with the instant disclosure;

FIG. 4 is a flow chart illustrating operation of a dispenser in accordance with a first embodiment in accordance with the instant disclosure; and

FIG. 5 is a flow chart illustrating operation of a dispenser in accordance with a second embodiment in accordance with the instant disclosure.

### DETAILED DESCRIPTION OF THE PRESENT EMBODIMENTS

As used herein, phrases substantially similar to “at least one of A, B or C” are intended to be interpreted in the disjunctive, i.e., to require A or B or C or any combination thereof unless stated or implied by context otherwise. Further, phrases substantially similar to “at least one of A, B and C” are intended to be interpreted in the conjunctive, i.e., to require at least one of A, at least one of B and at least one of C unless stated or implied by context otherwise. Further still, the term “substantially” or similar words requiring subjective comparison are intended to mean “within manufacturing tolerances” unless stated or implied by context otherwise.

As used herein, the phrase “operatively connected” refers to at least a functional relationship between two elements and may encompass configurations in which the two elements are directed connected to each other, i.e., without any intervening elements, or indirectly connected to each other, i.e., with intervening elements.

As used herein, the phrase “fluid communication” refers to a configuration between two or more elements in which fluid is able to flow in at least one direction between such elements.

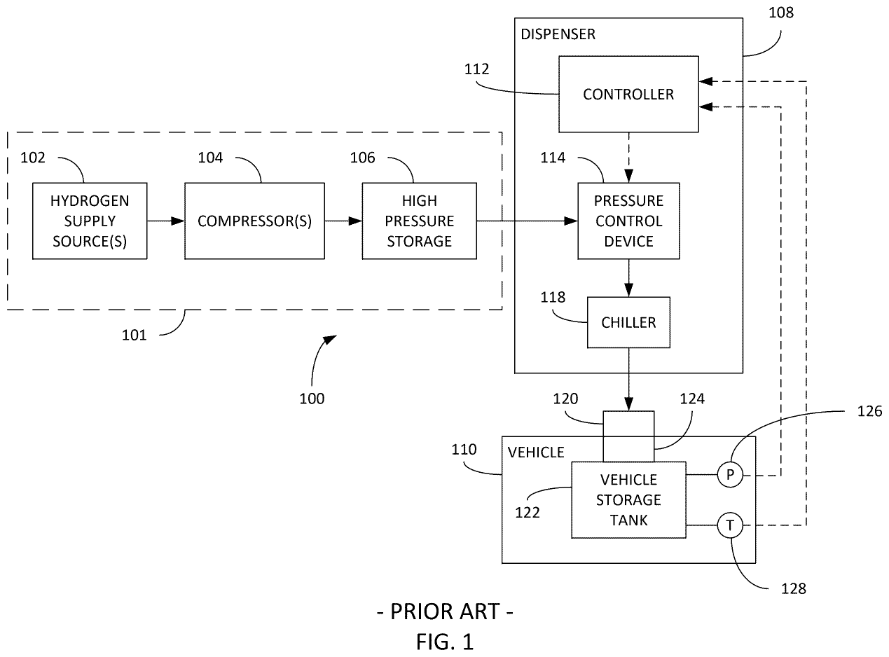

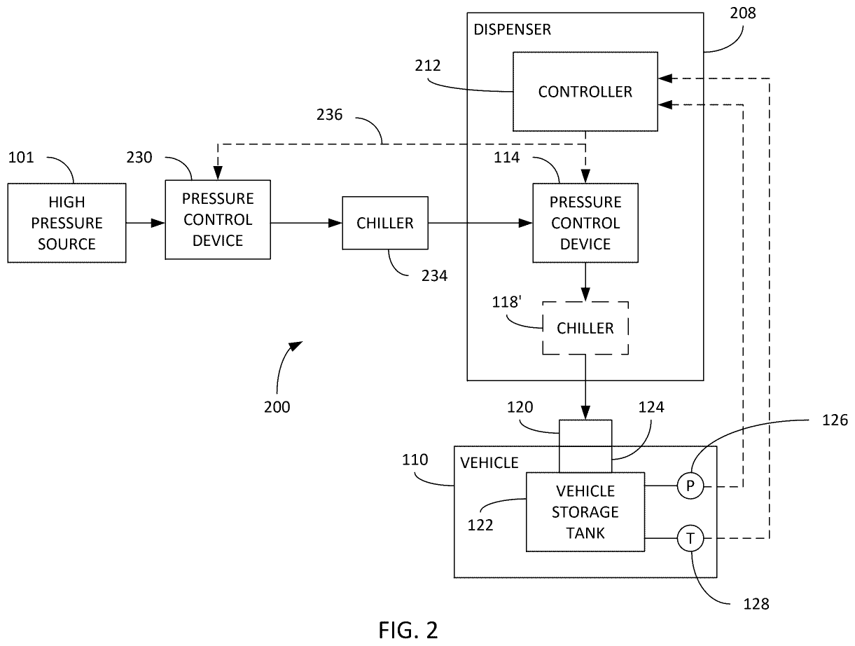

FIG. 2 illustrates an HRS 200 in accordance with the instant disclosure. As with the system 100 depicted in FIG. 1, the system of FIG. 2 once again comprises a high pressure source 101 that, as noted above, may be implemented in a variety of manners. Similarly, the system 200 comprises a dispenser 208 operatively connected to the high pressure source 101 that is operable to dispense gaseous hydrogen to a vehicle 110 having a receiving storage tank 122 as described above. In this case, however, the system 200 is provided with an additional pressure control device 230 (also referred to herein as a first or upstream pressure control device) as well as an external chiller 234. As shown, in embodiments in which the external chiller 234 is provided, the chiller 118′ in the dispenser 208 is optional.

Both the first pressure control device 230 and the pressure control device 114 deployed in the dispenser 208 (also referred to herein as a second or dispenser pressure control device) may comprise pressure control valve (PCVs) capable of being controlled by the controller 212 to vary the pressure provided at their respective outputs. However, the instant disclosure is not limited by the implementation of the pressure control devices 230, 114. For example, in another embodiment, either of the first or second pressure control devices 230, 114 may comprise a plurality of pressure control valves in parallel, where each of the plurality of valves provides different output pressure rates that may be combined to provide the desired pressure ramp rate.

The external chiller 234 may comprise any of a number of devices or systems capable of sufficiently decreasing the temperature of gaseous hydrogen supplied from the high pressure source 101 in order to meet the needs of the dispenser 208 when performing refill operations. For example, the external chiller 234 (as well as the chiller 118 deployed in the dispenser 208, if provided) may comprise a heat exchanger (such as an air-to-gas heat exchanger) and/or refrigeration unit as known in the art. Additionally, the external chiller 234 is capable of cooling the gaseous hydrogen received from the high pressure source 101 (via the first pressure control device 230) to such a degree that further pressure reduction within the dispenser 208 (via the second pressure control device 114) will not prevent the desired pressure ramp rate being met (with or without the optional chiller 118′). For example, in a presently preferred embodiment, the external chiller 234 is capable of cooling the gaseous hydrogen to about −40° C. at its output. Moreover, the external chiller 234 is preferably capable of achieving such cooling levels up to the maximum expected flowrate at its input. For example, in accordance with existing standards, maximum flow rates of about 60 g/s can be expected for the so-called H70 pressure class whereas maximum flow rates of about 120 g/s can be expected for the so-called H35 pressure class.

As shown, the first pressure control device 230 is in fluid communication with and configured to receive gaseous hydrogen from the high pressure source 101, whereas an output of the first pressure control device 230 is in fluid communication with and operatively connected to the external chiller 234. The external chiller 234 is also in fluid communication with and operatively connected to the second pressure control device 114 deployed in the dispenser 208. Both the first and second pressure control devices 230, 114 are operatively connected to the controller 212 that is configured to provide control signals via a control link 236 to the first and second pressure control devices 230, 114 when adjusting the pressure ramp rate during a refilling operation. For example, the control link 236 may comprise a communication bus implementing the well-known RS485 communication standard, though the instant disclosure is not limited in this regard as other suitable communication protocols and/or techniques, known to those skilled in the art, may be equally employed.

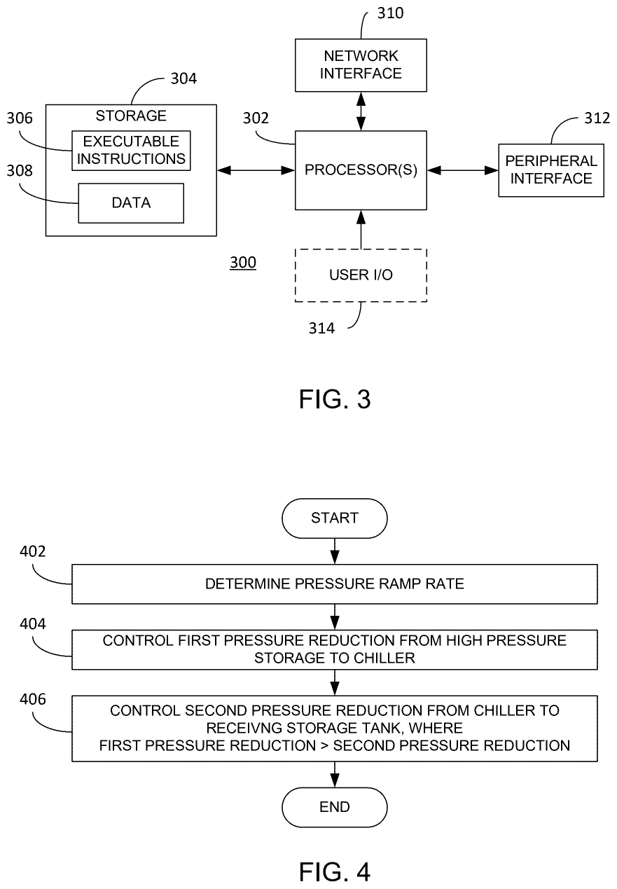

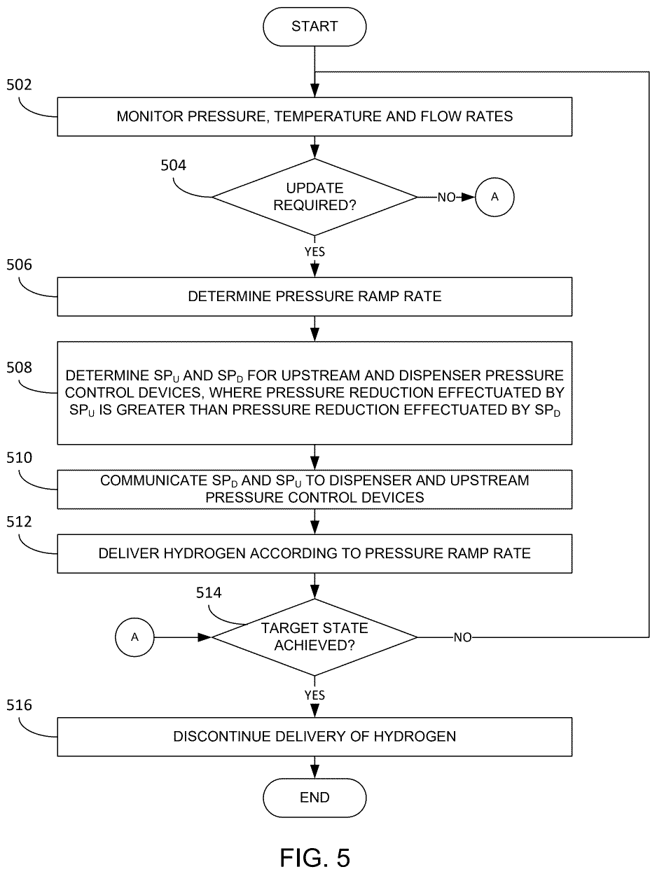

As noted above, the controller 212 may be embodied by a processing device, an example of which is illustrated in FIG. 3. Such a processing device 300 may be used to implement various aspects of the teachings of the instant disclosure, such as the processing illustrated in FIGS. 4 and 5, described in greater detail below. In the illustrated embodiment, the processing device 300 comprises a processor 302 coupled to a machine-readable storage component 304. The storage component 304, in turn, comprises stored executable instructions 306 and data 308. In an embodiment, the processor 302 may comprise one or more of a microprocessor, microcontroller, digital signal processor, co-processor or the like or combinations thereof capable of executing the stored instructions 306 and operating upon the stored data 308. Likewise, the storage component 304 may comprise one or more devices such as volatile or nonvolatile memory including but not limited to random access memory (RAM) or read only memory (ROM). Further still, the storage component 304 may be embodied in a variety of forms, such as a hard drive, optical disc drive, floppy disc drive, database and corresponding database management system (DBMS), etc. Processor and storage arrangements of the types illustrated in FIG. 3 are well known to those of skill in the art. In one embodiment, the processing techniques described herein are implemented as a combination of executable instructions and data within the storage component 304.

As shown, the processing device 300 may comprise a network interface 310, a peripheral interface 312 and (optionally) one or more user input/output devices 314 in communication with the processor 302. Though the network interface 310, the peripheral interface 312 and the one or more user input/output devices 314 are illustrated as being separately connected to or in communication with the processor 302, those having skill in the art will appreciate that the illustrated connections can be implemented by one or more communication buses and, further, that such buses may permit communication between the various components 310-314. Further still, while specific examples of components 310-314 are illustrated in communication with the processor 302, it is appreciated that various other components known to those skilled in the art may be equally used when implementing the processing device 300.

In an embodiment, the network interface 314 may comprise hardware, firmware and/or software that allows the processor 302 to communicate with other devices via wired or wireless networks, whether local or wide area, private or public, as known in the art. For example, such networks may include the World Wide Web or Internet, or private enterprise networks, as known in the art. The peripheral interface 312 may include the hardware, firmware and/or software necessary for communication with various peripheral devices, such pressure control devices as described herein, media drives (e.g., magnetic disk or optical disk drives), other processing devices (scanners, barcode readers, etc.) or any other input or output source (including other, similar processing devices) used in connection with the instant techniques. The user input/output devices 314, if provided, may comprise any mechanism for providing user input to the processor 302, or for providing output of the processor 302 to a user. For example, the user input device 306 may comprise a keyboard, a mouse, a touch screen (as part of a display, not shown), microphone and suitable voice recognition application or any other means whereby a user of the device 300 may interact with the processor 302.

While the device 300 has been described as one form for implementing the techniques described herein, those having ordinary skill in the art will appreciate that other, functionally equivalent techniques may be employed. For example, as known in the art, some or all of the functionality implemented via executable instructions may also be implemented using firmware and/or hardware devices such as application specific integrated circuits (ASICs), programmable logic arrays, state machines, etc. Furthermore, other implementations of the device 300 may include a greater or lesser number of components than those illustrated. Once again, those of ordinary skill in the art will appreciate the wide number of variations that may be used is this manner. Further still, although a single processing device 300 is illustrated in FIG. 3, it is understood that a combination of such processing devices may be configured to operate in conjunction (for example, using known networking techniques) to implement the teachings of the instant disclosure.

The instant disclosure addresses the heating issues attendant to depressurizing gaseous hydrogen through the provision of multiple reductions in pressure prior to dispensing. That is, the total pressure drop required to achieve a desired pressure ramp rate at a dispenser is accomplished through the provision of two or more pressure reductions between the high pressure source 101 and the receiving storage tank 122, where those reductions in pressure occurring before the external chiller 234 are greater than those reductions in pressure occurring within the dispenser 208. In this manner, the majority of hydrogen heating due to the reverse Joule-Thomson effect is incurred prior to the external chiller 234 such that any remaining heating incurred at the dispenser 208 may be more readily accounted for (or counteracted) within the dispenser 208.

FIG. 4 illustrates processing within a dispenser in accordance with a first embodiment. In particular, the processing illustrated in FIG. 4 may be carried out by the controller 212 in the form of stored instructions executed by a suitable processor as described above relative to FIG. 3. Further, though the elements illustrated in FIG. 2 are used to describe the processing illustrated in FIG. 4, it is appreciated that such processing is not necessarily limited to the system illustrated in FIG. 2 and may be applicable to any system in which gaseous hydrogen is routed from a high pressure source to a receiving storage tank. Thus, at block 402, during a refilling process, a determination is made of a pressure ramp rate currently required to deliver gaseous hydrogen to a receiving storage tank 122. To this end, the controller 212 may be configured to determine the pressure ramp rate according to the well-known MC formula based on any of a number of data inputs. For example, the pressure ramp rate may be based at least upon an initial pressure of the receiving storage tank, ambient temperature at the dispenser (via a suitable temperature sensor not shown in FIG. 2), pressure of the gaseous hydrogen delivered to the receiving storage tank, and temperature of the gaseous hydrogen delivered to the receiving storage tank. It is appreciated, however, that still other data may be relied upon for this purpose and the instant disclosure is not limited in this regard. For example, size of the receiving storage tank may considered in the pressure ramp rate determination. As known in the art, such size data is often represented in terms of total mass of hydrogen stored in the receiving storage tank when at the nominal working pressure of the storage tanks (usually 350 or 700 bar) and at 15 degrees Celsius. Alternatively, such data is also frequently expressed in the water volume in liters, e.g., in an H70 Nikola semi-truck, the receiving storage tank size is considered 65 kg or 1650 liters.

Thereafter, processing continues at block 404 where the controller 212 effectuates a first pressure reduction from the high pressure source 101 to the external chiller 234. Additionally, at block 406, the controller 212 effectuates a second pressure reduction from the external chiller 234 to the receiving storage tank 122, where the first pressure reduction is greater than the second pressure reduction. Though illustrated in FIG. 4 as being performed in a serial manner, the processing of blocks 404 and 406 may be carried out substantially simultaneously to the extent possible by the controller 212. In an embodiment, the total pressure reduction provided by the combination of the first pressure reduction and the second pressure reduction is at least as large as the pressure reduction needed to achieve the pressure ramp rate determined at block 402. For example, in an embodiment, the first pressure reduction may account for anywhere from about 51-80% of the overall pressure reduction required to achieve the desired pressure ramp rate. A more detailed embodiment of the processing performed by the controller 212 is further described below with reference to FIG. 5. In fact, various steps of the processing described with reference to FIG. 5 may be used to implement the processing described in FIG. 4, or in addition thereto.

FIG. 5 illustrates processing within a dispenser in accordance with a second embodiment, particularly where the upstream and dispenser pressure control devices 230, 114 are implemented as pressure control valves. In particular, the processing illustrated in FIG. may once again be carried out by the controller 212 in the form of stored instructions executed by a suitable processor as described above relative to FIG. 3. Further, though the elements illustrated in FIG. 2 are used to describe the processing illustrated in FIG. 5, it is appreciated that such processing is not necessarily limited to the system illustrated in FIG. 2 and may be applicable to any system in which gaseous hydrogen is routed from a high pressure source to a receiving storage tank. Thus, at block 502, during a refilling process, the controller 212 monitors pressure, temperature and flow rates of the gaseous hydrogen at various points throughout the system 200 to determine, at block 504, whether the currently measured data from block 502 indicates that the current pressure ramp rate is appropriate for continuing the refilling process or if an update to the pressure ramp rate is required. For example, the pressure ramp rate may be based at least upon an initial pressure of the receiving storage tank, ambient temperature at the dispenser (via a suitable temperature sensor not shown in FIG. 2), pressure of the gaseous hydrogen delivered to the receiving storage tank, temperature of the gaseous hydrogen delivered to the receiving storage tank, as well as the size of the receiving storage tank. It is once again appreciated, however, that still other data may be relied upon for this purpose and the instant disclosure is not limited in this regard.

If an update of the pressure ramp rate is not required at block 504, processing continues at block 514 where it is determined if a target state of the receiving storage tank 122 has been achieved. For example, the target state may be indicated by a certain quantity of hydrogen (e.g., as measured in kilograms) being added to the receiving storage tank 122, or a percentage of the maximum capacity (e.g., 95%) of the receiving storage tank 122 having been reached. When the target state is achieved, processing continues at block 516 where delivery of hydrogen to the receiving storage tank 122 is discontinued, i.e., the refilling process is complete.

On the other hand, if an update to the pressure ramp rate is required at block 504, as in the case, for example, where the pressure within the receiving storage tank 122 has increased such that a higher pressure ramp rate is required to continue refilling, processing continues at block 506 where the controller 212 determines an updated pressure ramp rate based on the most current pressure, temperature and flow rate values (or other data). Thereafter, at block 508, processing continues where the controller 212 determines a setpoint (SP_{U}) for the first or upstream pressure control device 230 as well as a setpoint (SP_{D}) for the second or dispenser pressure control device 114, where SP_{U} is greater than SP_{D}. As known in the art, such setpoints comprise data indicating the output pressure to be achieved by a pressure control valve. For example, if the controller 212 is trying to achieve a specific pressure ramp rate, the value of SP_{D} may be set such that the output pressure at the dispenser pressure control device 114 will match the desired pressure ramp rate, whereas the value of SP_{U} may be set to the value of SP_{D} plus a factor, X, such that the output pressure of the upstream pressure control device 230 will be higher than that to be achieved by SP_{D}. In this manner, the temperature increase of the hydrogen provided from the high pressure source 101 to the external chiller 234 via the upstream pressure control device 230 will be higher than the temperature increase resulting from traversal of the hydrogen from the external chiller 234 across the dispenser pressure control device 114. Once again, because the majority of the temperature increase is incurred prior to the external chiller 234, the chiller 118′ is optional. However, if the optional chiller 118′ is deployed in the dispenser, it will be better able to quickly and efficiently address any temperature increase incurred by the dispenser pressure control device 114.

At block 510, the setpoints SP_{U}, SP_{D} are communicated by the controller 212 to the respective upstream and dispenser pressure control devices 230, 114 via the control link 236. By having the controller 212 act as a single point of control, more precise control of the pressure ramp rate is achieved while reducing potential points of failure that may arise in a distributed control model. Thereafter, at block 512, the gaseous hydrogen is delivered to the receiving storage tank 122 according to the pressure ramp rate determined at block 506 and as implemented according to the setpoints determined and communicated at blocks 508 and 510, respectively. While delivery of the gaseous hydrogen is ongoing at block 512, the assessment of block 514 is once again undertaken to ascertain whether the target state of the receiving storage tank 212 has been achieved and, if not, processing continues at block 502 (again, while the hydrogen delivery of block 512 is ongoing) to once again determine if further adjustments to the pressure ramp rate are required.

While the various embodiments in accordance with the instant disclosure have been described in conjunction with specific implementations thereof, it is evident that many alternatives, modifications and variations will be apparent to those skilled in the art. Accordingly, the preferred embodiments of the invention as set forth herein are intended to be illustrative only and not limiting so long as the variations thereof come within the scope of the appended claims and their equivalents.

What is claimed is:

1. A method for controlling delivery of compressed gaseous hydrogen from a high pressure source to a receiving storage tank via an intervening dispenser that is operatively connected to the receiving storage tank and a chiller deployed between the high pressure source and the dispenser, the method comprising, in the dispenser:
determining a pressure ramp rate for providing the gaseous hydrogen to the receiving storage tank; and
controlling, based on the pressure ramp rate, a first reduction in pressure of the gaseous hydrogen from the high pressure source to the chiller; and
controlling, based on the pressure ramp rate, a second reduction in pressure from the chiller to the receiving storage tank,
wherein the first reduction in pressure of the gaseous hydrogen is greater than the second reduction in pressure of the gaseous hydrogen.

2. The method of claim 1 performed continuously by the dispenser.

3. The method of claim 1, wherein the controlling of the first reduction in pressure and the controlling of the second reduction in pressure occur substantially simultaneously.

4. The method of claim 1, further comprising:
operatively connecting the dispenser to a vehicle, wherein the receiving storage tank is deployed in the vehicle.

5. The method of claim 1, wherein determining the pressure ramp rate is based upon at least one of an initial pressure of the receiving storage tank, ambient temperature at the dispenser, pressure of the gaseous hydrogen delivered to the receiving storage tank, or temperature of the gaseous hydrogen delivered to the receiving storage tank.

6. The method of claim 1, wherein a first pressure control device is configured to receive the gaseous hydrogen from the high pressure source and provide the gaseous hydrogen to the chiller, and a second pressure control device is configured to receive the gaseous hydrogen from the chiller and provide the gaseous hydrogen to the receiving storage tank, wherein controlling the first reduction in pressure and the second reduction in pressure further comprises:
communicating a first operating setpoint to the first pressure control device, wherein the first reduction in pressure of the gaseous hydrogen is effectuated by the first pressure control device operating according to the first operating setpoint; and
communicating a second operating setpoint to the second pressure control device, wherein the second reduction in pressure of the gaseous hydrogen is effectuated by the second pressure control device operating according to the second operating setpoint.

7. The method of claim 6, further comprising:
determining the first operating setpoint based upon the temperature, pressure and flow rate of the gaseous hydrogen at the first pressure control device; and
determining the second operating setpoint based upon the temperature, pressure and flow rate of the gaseous hydrogen at the second pressure control device.

8. The method of claim 1, further comprising:
delivering the gaseous hydrogen to the receiving storage tank according to the pressure ramp rate.

9. The method of claim 8, further comprising:
discontinuing delivery of the gaseous hydrogen to the receiving storage tank when a target state of the receiving storage tank is achieved.

10. A dispenser for use in a gaseous hydrogen dispensing system, the dispenser comprising:
a dispenser pressure control device configured to receive gaseous hydrogen from a chiller;
a nozzle, in fluid communication with the dispenser pressure control device and configured to be in fluid communication with a receiving storage tank in a vehicle;
a controller operatively connected to the dispenser pressure control device and having a processing device configured to:
determine a pressure ramp rate for providing the gaseous hydrogen to the receiving storage tank via the nozzle;
determine, based on the pressure ramp rate, a dispenser operating setpoint for the dispenser pressure control device, wherein a dispenser reduction in pressure of the gaseous hydrogen is effectuated by the dispenser pressure control device when operating according to the dispenser operating setpoint;
determine, based on the pressure ramp rate, an upstream operating setpoint for an upstream pressure control device that is upstream of, and configured to provide the gaseous hydrogen to, the chiller, wherein an upstream reduction in pressure of the gaseous hydrogen is effectuated by the upstream pressure control device when operating according to the upstream operating setpoint, and wherein the upstream reduction in pressure of is greater than the dispenser reduction in pressure; and
communicating the dispenser operating setpoint to the dispenser pressure control device and the upstream operating setpoint to the upstream pressure control device.

11. The dispenser of claim 10, wherein the processing device is further configured to determine the pressure ramp rate is based upon at least one of an initial pressure of the receiving storage tank, ambient temperature at the dispenser, pressure of the gaseous hydrogen delivered to the receiving storage tank, or temperature of the gaseous hydrogen delivered to the receiving storage tank.

12. The dispenser of claim 10, wherein the processing device is further configured to:
determine the dispenser operating setpoint based upon the temperature, pressure and flow rate of the gaseous hydrogen at the dispenser pressure control device; and
determine the upstream operating setpoint based upon the temperature, pressure and flow rate of the gaseous hydrogen at the upstream pressure control device.

13. The dispenser of claim 10, wherein the processing device is further configured to:
deliver the gaseous hydrogen to the receiving storage tank via the dispenser pressure control device according to the pressure ramp rate.

14. The dispenser of claim 13, wherein the processing device is further configured to:
discontinue delivery of the gaseous hydrogen to the receiving storage tank when a target state of the receiving storage tank is achieved.

15. A gaseous hydrogen dispensing system comprising:
a high pressure source of gaseous hydrogen;
a first pressure control device configured to receive the gaseous hydrogen from the high pressure source;
a chiller configured to receive the gaseous hydrogen from the first flow pressure control device;
a dispenser in fluid communication with the chiller and a receiving storage tank, the dispenser comprising a second pressure control device configured to receive the gaseous hydrogen from the chiller and deliver the gaseous hydrogen to the receiving storage tank, the dispenser further comprising a controller operatively connected to the first pressure control device and the second pressure control device, the controller configured to:
determine a pressure ramp rate for providing the gaseous hydrogen to the receiving storage tank; and
controlling the first pressure control device according to a first operating setpoint and the second pressure control device according to a second operating setpoint,
wherein the first operating setpoint and the second operating setpoint are based on the pressure ramp rate,
and wherein a first reduction in pressure of the gaseous hydrogen by the first pressure control device according to the first operating setpoint is greater than a second reduction in pressure of the gaseous hydrogen by the second pressure control device according to the second operating setpoint.

16. The system of claim 15, wherein the high pressure source is an output of a storage tank.

17. The system of claim 15, wherein the high pressure source is an output of a compressor.

18. The system of claim 15, wherein the chiller is configured to cool the gaseous hydrogen to about −40° C.

19. The system of claim 15, wherein determining the pressure ramp rate is based upon at least one of an initial pressure of the receiving storage tank, ambient temperature at the dispenser, pressure of the gaseous hydrogen delivered to the receiving storage tank, or temperature of the gaseous hydrogen delivered to the receiving storage tank.

20. The system of claim 15, wherein:
the first operating setpoint is based upon the temperature, pressure and flow rate of the gaseous hydrogen at the first pressure control device, and
the second operating setpoint is based upon the temperature, pressure and flow rate of the gaseous hydrogen at the second pressure control device.

21. The system of claim 15, wherein the receiving storage tank is deployed in a vehicle.
